(19) United States
(12) Patent Application Publication
(10) Pub. No.: US 2021/0119407 A1
(43) Pub. Date: Apr. 22, 2021

(54) METHOD AND DEVICE FOR PROTECTING THE LASER OPTICS OF A LASER SYSTEM AGAINST AGING

(71) Applicant: PHOTON ENERGY GMBH, Ottensoos (DE)

(72) Inventor: WOLFGANG SCHUESSLBAUER, BOPPELSEN (CH)

(21) Appl. No.: 16/743,298

(22) Filed: Jan. 15, 2020

(30) Foreign Application Priority Data
Oct. 22, 2019 (DE) 10 2019 216 259

(51) Int. Cl. H01S 5/00; G02B 1/115; G02B 1/14

(52) U.S. Cl. CPC H01S 5/0064; H01S 5/068; G02B 1/14; G02B 1/115

(57) ABSTRACT

A device for protecting laser optics against aging and an associated laser system. The device has a beam displacement element, which is or may be placed upstream of the laser optics, for parallel displacement or tilting of a laser beam incident along an optical axis. The device additionally has an adjusting apparatus coupled to the first beam displacement element, by way of which the position of the beam displacement element, or a part thereof, may be adjusted, in order to change a point of impact of the laser beam on the laser optics. The laser optics requiring protection are in particular a resonator mirror, an optical amplifier, a semiconductor absorber mirror or a non-linear crystal.

### CROSS-REFERENCE TO RELATED APPLICATION

This application claims the priority, under 35 U.S.C. § 119, of German patent application DE 10 2019 216 259.2, filed Oct. 22, 2019; the prior application is herewith incorporated by reference in its entirety.

### BACKGROUND OF THE INVENTION

### Field of the Invention

The invention relates to a device to protect laser optics from aging. The invention also relates to a laser system that has laser optics inside or outside a laser resonator that requires protection against aging, and to a method of operating such a laser system.

The term “laser system” is generally used to describe an optical system for generating and optionally guiding, shaping, converting and/or amplifying a laser beam. Such a laser system typically comprises a laser resonator that generates the laser beam and, if applicable, other optical components—which vary depending on the type of laser system.

The term “laser optics” generally refers to a certain optical component intended for use in a laser system—inside or outside the laser resonator—in particular a resonator mirror, an optical amplifier (power amplifier), a semiconductor absorber mirror (SESAM) or a non-linear crystal, such as is used for example for frequency conversion of the laser beam.

In laser systems with medium and high peak intensities, which are used for example for marking and also for cutting, milling or welding work, the laser optics of the respective laser system are regularly exposed to high loads in the beam region and are therefore frequently subject to rapid, localized aging (wear) at the affected locations. In order to delay the need for the replacement of the affected laser components and the associated operating costs as much as possible, locally-worn laser optics, for example resonator mirrors, are sometimes shifted or rotated perpendicularly to the laser beam, so that the point of impact of the laser beam on the laser optics is changed. One challenge in this is the required precision of the adjustment mechanism that must be used for this purpose, because the clearance of the adjustment mechanism required in order to make the adjustment may lead to a misalignment of the laser system and thus to mode instability or other malfunctions of the laser system. As a result, suitable adjustment mechanisms are very cumbersome and expensive.

### SUMMARY OF THE INVENTION

It is accordingly an object of the invention to provide a method and a device, which overcome the above-mentioned and other disadvantages of the heretofore-known devices and methods of this general type and which enables laser optics to be protected against aging (i.e., wear) caused by the load of the laser beam, in a simple but effective way. The term “protection against aging” herein comprises any measure that delays the aging of the laser optics that would impair or prevent the continued use of the laser optics as a whole, and thus enables a particularly long-term use of the laser optics in a laser system. The term “protection against aging” thus also includes, in particular, those measures that accept local aging (wear) of the laser optics but enable continued use of the laser optics in spite of this local aging.

With the above and other objects in view there is provided, in accordance with the invention, a device for protecting laser optics from aging, the device comprising:

a beam displacement element disposed upstream of the laser optics in a beam travel direction for a parallel displacement or tilting of a laser beam impinging along an optical axis;

an adjusting apparatus coupled to said first beam displacement element and configured for adjusting a position of said beam displacement element or a part thereof in order to change a point of impact of the laser beam on the laser optics.

The laser optics, by way of example, is a resonator mirror, an optical amplifier, a semiconductor absorber mirror, and/or a non-linear crystal.

The laser optics requiring protection is arranged inside a laser resonator (hereinafter “internal laser optics”), for example a resonator mirror or a semiconductor absorber mirror (SESAM), or an optics arranged outside the laser resonator (hereinafter “external laser optics”), for example an optical amplifier or a non-linear crystal.

With the above and other objects in view there is also provided, in accordance with the invention, a method of operating a laser system having laser optics arranged in a beam path of a laser beam, the method comprises variably displacing the laser beam in parallel (by a parallel-shift) or by tilting with a beam displacement element disposed upstream of the laser optics to thereby change a point of impact of the laser beam on the laser optics in order to protect the laser optics from aging.

In other words, the objects of the invention are achieved, according to the invention, by a beam displacement element designed for parallel displacement or tilting of a laser beam inclined along an optical axis is used to change the point of impact of a laser beam on laser optics downstream of the beam displacement element, in order to protect the laser optics from aging. Thus, instead of adjusting the laser optics that require protection, the upstream beam displacement element is adjusted. This has the advantage that the laser optics that require protection do not need to be moved (and are not moved), thus avoiding the risk of misalignment of the laser system associated with adjustability or adjustment of the laser optics. An adjustment apparatus associated with the laser optics is no longer necessary and therefore preferably also not present, so as to save the manufacturing effort associated with such an adjusting apparatus.

The protective device according to the invention comprises a first beam displacement element that is or may be located upstream of the laser optics, which effects a parallel displacement or tilting of a laser beam that is incident along an optical axis. The protective device further comprises a first adjusting apparatus coupled to the first beam displacement element, by means of which the location (i.e. the position and/or orientation) of the first beam displacement element or a part thereof is adjustable, so that the point of impact of the laser beam on the laser optics may be changed.

The laser system according to the invention comprises a laser resonator for generating a laser beam and the above-described protective device.

A substantial advantage of the invention is that the beam displacement element and the associated positioning apparatus may be manufactured with comparatively little difficulty. This is due in particular to the fact that the exact position of the beam displacement element is not critical for the functioning of the laser system. The adjusting apparatus associated with the beam displacement element is therefore not required to have a high level of mechanical precision.

Preferably, the beam displacement element may be rotated about any axis of rotation oriented in any manner relative to the optical axis (for example coaxial, parallel, intersecting or skewed), using the adjusting apparatus. Additionally or alternatively, the beam displacement element may be tilted around a tilt axis arranged perpendicular to the axis of rotation, using the adjusting apparatus.

In a particularly simple and expedient embodiment, the beam displacement element is formed by a plane-parallel transparent plate or a transparent wedge plate that is arranged obliquely to the optical axis. Alternatively, the beam displacement element within the scope of the invention may also be formed by a reflective element, in particular by a pair of mirrors that are plane-parallel or tilted relative to one another.

In order to minimize an undesired influence of the beam displacement element on the polarization of the laser beam, an entry surface of the beam displacement element on which the incident laser beam impinges is preferably furnished with an anti-reflective coating.

In an advantageous embodiment of the invention, in addition to the first beam displacement element described above, a second beam displacement element is furnished that is or may be placed downstream of the laser optics requiring protection. This second beam displacement element is used for parallel displacement or tilting of the laser beam that the laser optics reflect or transmit, so as to compensate for the parallel displacement or tilting of the laser beam caused by the first beam displacement element. The second beam displacement element deflects the laser beam, which was deflected away from the optical axis by the first beam displacement element, in particular back to the optical axis.

The second beam displacement element is preferably adjustable so that position (i.e. the position and/or orientation) of the second beam displacement element tracks an adjustment of the first beam displacement element. The position of the second beam displacement element is thus adjustable (and is adjusted) such that the second beam displacement element always compensates for the parallel displacement or tilting of the laser beam caused by the first beam displacement element, irrespective of the position of the first beam displacement element. In an expedient configuration, for this purpose, the second beam displacement element is likewise coupled with the first adjusting apparatus. For example, the first beam displacement element and the second beam displacement element are mounted on a common shaft of the first adjusting apparatus so that they are rotationally fixed relative to one another but may be rotated together relative to the surrounding space. In an alternative embodiment of the invention, the second beam displacement element is coupled to a second adjusting apparatus (separate from the first adjusting apparatus). The second adjusting apparatus moves the second displacement element to follow any adjustment of the first beam displacement element.

The second beam displacement element is also preferably formed by a plane-parallel transparent plate or a transparent wedge plate, arranged obliquely to the optical axis. Alternatively, within the scope of the invention, the second beam displacement element may also be formed by a reflective element, in particular a pair of plane-parallel or mutually-tilted mirrors. The first beam displacement element and second beam displacement element are preferably similar in design.

During operation of the laser system, the location of the point of impact on the laser optics requiring protection is preferably changed by adjusting the respective beam displacement element or elements when the function of the laser system is impaired by local aging (wear) of the laser optics.

Alternatively, the location of the point of impact is proactively changed at shorter intervals, so that the respective laser optics requiring protection undergo wear uniformly over a longer period of time and over a larger area (relative to the diameter of the laser beam). In particular, the point of impact changes at such brief intervals that there is no discernible wear of the respective laser optics between two changes, or even continuously during operation of the laser system. The proactive, in particular continuous change of the point of impact is preferably used in applications where thermal effects (in particular local overheating) play a significant role in the aging of the laser optics requiring protection, because the proactive movement of the laser beam relative to the laser optics enables effective heat dissipation.

Other features which are considered as characteristic for the invention are set forth in the appended claims.

Although the invention is illustrated and described herein as embodied in a method and device for protecting the laser optics of a laser system against aging, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a laser system having a laser resonator for generating a laser beam that propagates along an optical axis, the laser resonator comprising an end mirror and a protective device for protecting the end mirror from aging;

FIG. 2 is a more detailed schematic illustration of the end mirror and the associated protective device, the end mirror being formed by a plane mirror, and the protective device having a beam displacement element for parallel displacement of the laser beam, in the form of a transparent plane-parallel plate aligned obliquely relative to the optical axis, the plane-parallel plate being rotatable about an axis of rotation parallel to the optical axis using an adjusting apparatus in order to change the point of impact of the laser beam on the end mirror;

FIG. 3 is a view, similar to that of FIG. 2, of a variant of the protective device shown therein, in which the plane-parallel plate may additionally be tilted transversely to its axis of rotation in order to change the point of impact of the laser beam on the end mirror;

FIG. 4 is a view, similar to that of FIG. 2, of an alternative embodiment of the laser system, in which the end mirror is formed by a spherical end mirror, and in which the protective device has a transparent wedge plate as the beam displacement element; and

FIG. 5 is a schematic illustration of another embodiment of the laser system, having laser optics arranged outside the laser resonator, in this case in the form of a non-linear crystal, and having a (protective) device for protecting this laser optics, wherein the protective device has two beam displacement elements upstream or downstream of the laser optics, each respectively in the form of a transparent plane-parallel plate.

Parts, elements, and structures that correspond to one another are assigned the same reference signs throughout the drawing figures.

### DETAILED DESCRIPTION OF THE INVENTION

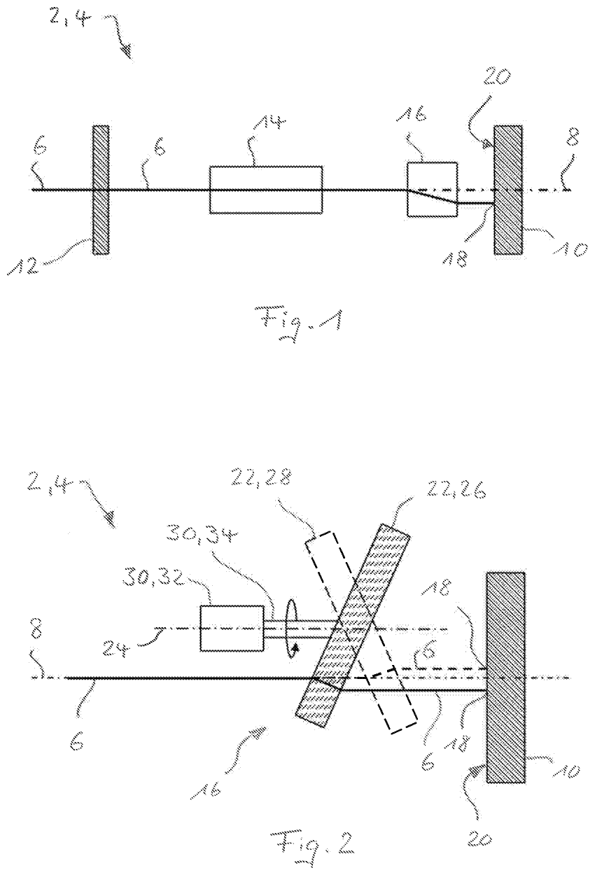

Referring now to the figures of the drawing in detail and first, particularly, to FIG. 1 thereof, there is shown a rough schematic depiction of a (laser) resonator 2 of a laser system 4. The resonator 2 serves to generate a laser beam 6 and to this end comprises, as is conventional, two resonator mirrors facing one another along an optical axis 8, namely a fully reflecting (end) mirror 10 and a partially reflecting (output coupler) mirror 12, as well as an active optical medium 14 arranged between the mirrors 10 and 12.

Deviating from the conventional design, the resonator 2 in FIG. 1 additionally comprises a (protective) device 16 for protecting internal laser optics of the resonator 2, in this case the end mirror 10, from aging. The device 16 is upstream of the end mirror 10 and causes a variable deflection of the laser beam 6 from the optical axis 8. The device 16 may thus change a point of impact 18 where the laser beam 6 impinges on a surface 20 of the end mirror 10. By changing the point of impact 18, the energy input into the material of the end mirror 10 that the laser beam 6 causes, and the resulting load on the mirror material, are distributed over a larger area compared to the diameter of the laser beam, thus extending the service life (lifetime) of the end mirror 10 multiple times over.

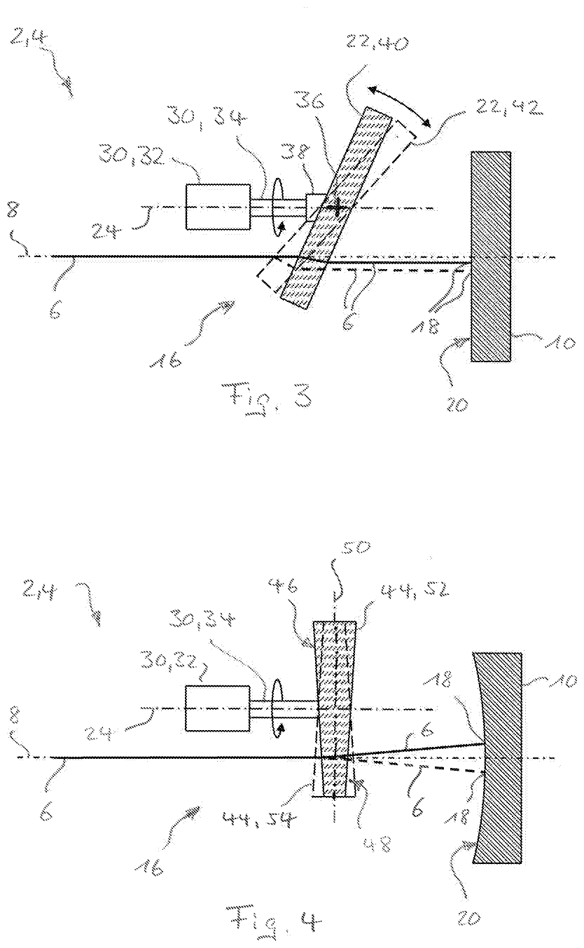

FIG. 2 shows a first embodiment of the end mirror 10 and the associated protective device 16 in more detail, although still in a rough schematic fashion. The end mirror 10 in this case is designed as a plane (i.e. flat) mirror. The associated protective device 16 is designed to cause a parallel displacement of the laser beam 6 relative to the optical axis 8, and to this end, it has a transparent plane-parallel plate 22, in particular made of glass, as the beam displacement element. The plate 22 is mounted obliquely to the optical axis 8 and rotatably about an axis of rotation 24 parallel to the optical axis 8 in the resonator 2, so that the plate 22 intersects the optical axis 8 obliquely in each rotational position. FIG. 2 shows the plate 22 with solid lines or dashed lines in two rotational positions 26 and 28 that are displaced by an angle of rotation of 180°. As this illustration shows, when the plate 22 is rotated, the laser beam 6 and thus the point of impact 18 are guided on a circular path around the optical axis 8.

To rotate the plate 22 and thus change the point of impact 18, the protective device 16 comprises an adjusting apparatus 30. In the embodiment shown in FIG. 2, the adjusting apparatus 30 is formed, for example, by an electric stepping motor 32 on the shaft 34 of which the plate 22 is mounted fixedly (against tilting).

FIG. 3 shows a variant of the device 16, in which the plate 22 is not only rotatable about the axis of rotation 24, but may also be tilted about a tilt axis 36 perpendicular to the axis of rotation 24 (and thus perpendicular to the optical axis 8). For tilting the plate 22, the adjusting apparatus 30 here additionally comprises an actuator 38 (for example a piezoelectric actuator). FIG. 3 shows the plate 22 with solid lines or dashed lines in two different tilting positions 40 and 42. As this illustration shows, the increasing tilting of the plate 22 increases the distance of the laser beam 6, and thus of the point of impact 18, from the optical axis 8.

In another variant, not explicitly shown, of the device 16 for protecting the flat end mirror 10, the plane-parallel plate 22 may only be tilted about the tilt axis 36, but is not rotatable about the axis of rotation 24. The plate 22, in this case, is thus mounted to be rotationally fixed with respect to a rotation about either the optical axis 6 or a parallel rotation axis in the resonator 2. In this embodiment, the adjusting apparatus 30 only has the actuator 38, but not the stepping motor 32 and shaft 34.

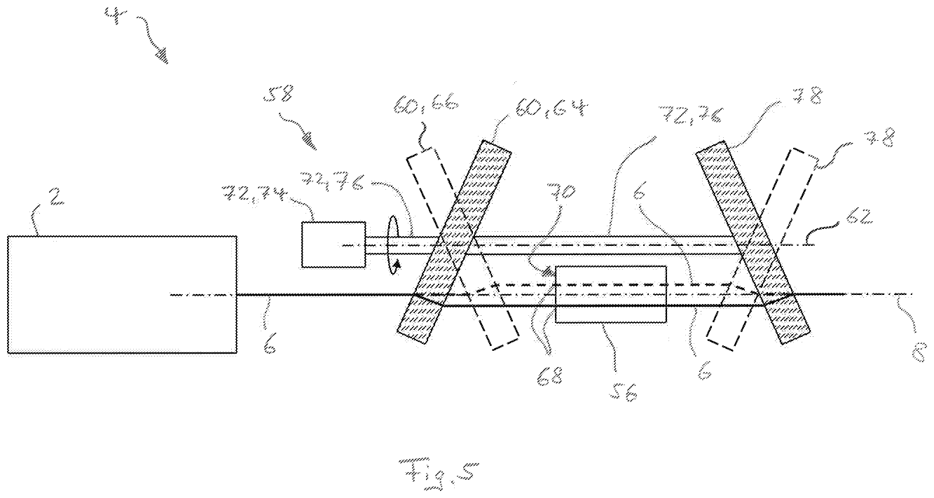

FIG. 4 shows another embodiment of the resonator 2 and protective device 16. In contrast to the above-described embodiments, here the mirror 10 of the resonator 2 is designed as a spherical mirror. The device 16 that is furnished in turn to protect the end mirror 10 is designed to tilt the laser beam 6 relative to the optical axis 8 so that the laser beam 6 strikes at an offset from optical axis 8 at a distance but is always perpendicular to the surface 20 of the end mirror 10.

In the embodiment shown in FIG. 4, the device 16 has a transparent wedge plate 44, in particular made of glass, as a beam displacement element. The wedge plate 44 has two end faces 46 and 48 that intersect the optical axis 8 and are aligned obliquely to one another. Analogously to the embodiment shown in FIG. 2, the wedge plate 44 is mounted on the shaft 34 of the stepping motor 32 so as to be rotatable about the axis of rotation 24. In contrast to the embodiment shown in FIG. 2, the wedge plate 44 is mounted in such a way that its plane of symmetry 50 is arranged perpendicular to the optical axis 8 and the axis of rotation 24. The two end faces 46 and 48 thus cut the optical axis 8 mirror-symmetrically at angles that complement one another for a total of 180°. FIG. 4 shows the wedge plate 44, with solid lines or dashed lines, in two rotational positions 52 and 54 that are offset by a 180° angle of rotation.

In the embodiment shown in FIG. 4, the wedge plate 44 is fixed (against tilting) on the shaft 34. In a variant of the device 16, not explicitly shown in FIG. 4, a combination of two wedge plates is furnished to serve as the beam displacement element, and these wedge plates are arranged on the axis of rotation 24 so as to be rotatable relative to one another in order to change the (total) wedge angle of the two wedge plates.

In all the exemplary embodiments described above, the laser beam 6, which is offset in parallel or tilted by the protective device 16, is reflected into itself by the end mirror 10. After reflection in the end mirror 10, the beam thus returns in the same way through the plane-parallel plate 22 or the wedge plate 44. Both end faces of the parallel plate 22 and the two end faces 46 and 48 of the wedge plate 44 thus form entry surfaces for the laser beam 6. In order to prevent the polarization of the laser beam 6 from being influenced by partial reflection at these entry surfaces, the end faces of the parallel plate 22 and the two end faces 46 and 48 of the wedge plate 44 are preferably furnished with a (polarization-independent) anti-reflective coating.

Finally, FIG. 5 shows a embodiment of the laser system 4 in which this system has an external laser optics 56 in addition to the resonator 2 (shown here only schematically). The external laser optics 56, for example, is a non-linear crystal that is used in particular for frequency conversion of the laser beam 6. Alternatively, the laser optics 56 may for example be formed by an optical amplifier (power amplifier).

The laser system 4 shown in FIG. 5 has a (protective) device 58 for protecting the laser optics 56. The protective device 58 comprises—analogously to the protective device 16 from FIG. 2—a transparent plane-parallel plate 60, in particular made of glass, as the first beam displacement element, which is placed upstream of the laser optics 56 and displaces the laser beam 6 incident on the laser optics 56 parallel to the optical axis 8. The plate 60 is mounted obliquely to the optical axis 8 and rotatably about an axis of rotation 62 parallel to the optical axis 8, so that the plate 60 intersects the optical axis 8 obliquely in each rotational position. In FIG. 5, the plate 60 is shown with solid lines or dashed lines in two rotational positions 64 and 66 that are offset by an angle of rotation of 180°. As with the exemplary embodiment shown in FIG. 2, the laser beam 6 and thus its point of impact 68 on a surface 70 of the laser optics 56 are guided on a circular path around the optical axis 8 when the plate 60 is rotated.

Likewise analogously to the exemplary embodiment shown in FIG. 2, the protective device 58 for rotating the plate 60 and thus for changing the point of impact 68 comprises an adjusting apparatus 72, for example in the form of an electric stepping motor 74, on the shaft 76 of which the plate 60 is mounted fixedly (against tilting).

In addition to the plate 60, the protective device 58 comprises as a second beam displacement element an additional transparent plane-parallel plate 78, in particular made of glass, which is placed downstream of the laser optics 56 and deflects back to the optical axis 8 the laser beam 6 reflected or transmitted by the laser optics 56. This second plate 78 is arranged mirror-symmetrically to the first plate 60 and always tracks a rotation of the first plate 60. For this purpose, the plates 60 and 78 are preferably coupled to one another with the shaft 76 so that they are rotationally fixed, as FIG. 5 shows. Alternatively, a separate second adjusting apparatus (i.e. mechanically detached from the adjusting apparatus 72) is associated with the plate 78. In this case, this second adjusting apparatus and the adjusting apparatus 72 are synchronously controlled so that the plate 78 follows a rotation of the first plate 60.

Additionally or alternatively to the rotatability described above, in additional variants of the protective device 58 the two plates 60 and 78 may be tilted—analogously to FIG. 3, but always opposite one another—in order to change the strength of the parallel offset of the laser beam 6 (i.e. the distance of the parallel-displaced laser beam 6 from the optical axis 8).

In order to prevent the polarization of the laser beam 6 from being influenced by partial reflection at the plates 60 and 78, the end faces of these plates 60 and 78 facing toward the resonator 2 (which in turn form entry surfaces for the laser beam 6) are preferably furnished with an anti-reflective coating.

In the operation of the above-described embodiments of the laser system 4, the location of the point of impact 18 or 68 on the end mirror 10 or the external laser optics 56 is preferably changed by adjusting the respective beam displacement elements, i.e. the plane-parallel plates 22, 60 or the wedge plate 44, whenever the function of the laser system 4 is impaired by local aging (wear) of the associated laser optics, i.e. the end mirror 10 or external laser optics 56. Alternatively, for this purpose the respective device 16 or 58 changes the location of the point of impact 18 or 68 of the laser beam 6 on the respective laser optics requiring protection proactively, in particular continuously.

The invention has been made particularly clear in the exemplary embodiments described above, but is not limited thereto. Rather, additional embodiments of the invention may be derived from the claims and the above description.

Following is a list of reference numerals used in the above description and in the drawing figures:
2 (Laser) resonator
4 Laser system
6 Laser beam
8 (Optical) axis
10 (End) mirror
12 (Decoupling) mirror
14 (Active optical) medium
16 (Protective) device
18 Point of impact
20 Surface (of the end mirror)
22 (Plane-parallel) Plate
24 Rotation axis
26 Rotational position
28 Rotational position
30 Adjusting apparatus
32 Stepping motor
34 Shaft
36 Tilt axis
38 Actuator
40 Tilt position
42 Tilt position
44 Wedge plate
46 End face
48 End face
50 Plane of symmetry
52 Rotational position
54 Rotational position
56 (External) laser optics
58 (Protective) device
60 (Plane-parallel) Plate
62 Rotation axis
64 Rotational position
66 Rotational position
68 Point of impact
70 Surface
72 Adjusting apparatus
74 Stepping motor
76 Shaft
78 (Plane-parallel) Plate

1. A device for protecting laser optics from aging, the device comprising:
a beam displacement element disposed upstream of the laser optics in a beam travel direction for a parallel displacement or tilting of a laser beam impinging along an optical axis;
an adjusting apparatus coupled to said first beam displacement element and configured for adjusting a position of said beam displacement element or a part thereof in order to change a point of impact of the laser beam on the laser optics.

2. The device according to claim 1, wherein the laser optics is an element selected from the group consisting of a resonator mirror, an optical amplifier, a semiconductor absorber mirror, and a non-linear crystal, and said beam displacement element is configured to deflect the laser beam upstream of the laser optics element.

3. The device according to claim 1, wherein said beam displacement element is rotatable, for rotation by said adjusting apparatus, about an axis of rotation that is oriented arbitrarily with respect to the optical axis.

4. The device according to claim 3, wherein said beam displacement element is tiltable, for tilting by said adjusting apparatus, about a tilt axis arranged perpendicular to the axis of rotation.

5. The device according to claim 1, wherein said beam displacement element comprises a transparent plane-parallel plate arranged obliquely to the optical axis.

6. The device according to claim 1, wherein said beam displacement element comprises a transparent wedge plate.

7. The device according to claim 1, which comprises an anti-reflective coating on an entry surface of said beam displacement element, on which the incident laser beam impinges.

8. The device according to claim 1, wherein said beam displacement element is a first beam displacement element and the device further comprises a second beam displacement element downstream of the laser optics for parallel displacement or tilting of the laser beam reflected or transmitted by the laser optics, in order to compensate for the parallel displacement or tilting of the laser beam caused by said first beam displacement element.

9. The device according to claim 8, wherein a position of said second beam displacement element or a part thereof is adjustable by said adjusting apparatus or a separate further adjusting apparatus, so as to track the position of said second beam displacement element to follow an adjustment of said first beam displacement element.

10. A laser system, comprising:
a laser resonator for generating a laser beam;
laser optics disposed inside or outside of said laser resonator; and
a device according to claim 1 for protecting said laser optics from aging.

11. A method of operating a laser system having laser optics arranged in a beam path of a laser beam, the method comprising:
variably displacing the laser beam in parallel or by tilting with a beam displacement element disposed upstream of the laser optics to thereby change a point of impact of the laser beam on the laser optics in order to protect the laser optics from aging.

12. The method according to claim 11, which comprises displacing the laser beam with a transparent plane-parallel plate or a transparent wedge plate.

13. A method of displacing a laser beam, the method comprising:
providing a beam displacement element configured for parallel displacement of the laser beam or for tilting the laser beam incident along an optical axis, in order to change a point of impact of the laser beam on laser optics downstream of the beam displacement element and in order to protect the laser optics from aging.

14. The method according to claim 13, which comprises parallel-shifting or tilting the laser beam with a transparent plane-parallel plate or with a transparent wedge plate.
